(19) United States
(12) Patent Application Publication
(10) Pub. No.: US 2021/0127609 A1
(43) Pub. Date: May 6, 2021

(54) Hydroponics System and Method

(71) Applicant: Garden Island Robotics Inc., Princeville, HI (US)

(72) Inventor: Jimmy C. Brake, JR., Princeville, HI (US)

(73) Assignee: Garden Island Robotics Inc., Princeville, HI (US)

(21) Appl. No.: 17/082,863

(22) Filed: Oct. 28, 2020

Related U.S. Application Data
(60) Provisional application No. 62/928,179, filed on Oct. 30, 2019.

(51) Int. Cl. A01G 31/06; G05B 19/042; G06T 7/00; G06T 7/90

(52) U.S. Cl. CPC A01G 31/06; G05B 19/042; A01G 2031/006; G06T 7/90; G06T 7/0012

(57) ABSTRACT

A hydroponics system that uses image processing techniques to automatically manage nutrients is disclosed. The hydroponics system allows small amounts of nutrients to be added to circulated solution on a frequent basis. Images of plants located in a growing area are processed by a computer processor to determine whether the plants are growing. If the plants are growing, the computer processor causes more nutrients to be added to the system than if plants are not growing.

### CROSS-REFERENCE TO RELATED APPLICATIONS

The present applications claims priority to the earlier filed provisional application having Ser. No. 62/928,179, filed Oct. 30, 2019 and entitled “Hydroponics System”, and hereby incorporates the subject matter of the provisional application in its entirety.

### FIELD OF INVENTION

The present disclosure is directed in general to hydroponics systems, and more particularly, to hydroponics systems using image processing to manage nutrient levels.

### BACKGROUND

A background is provided for introductory purposes and to aid the reader in understanding the detailed description. The background should not be taken as an admission of any prior art claims.

Conventional hydroponic systems may require growers to add large amounts of nutrients to the system every 10-14 days. Adding large amounts of nutrients at one time can cause several problems.

First, destabilization may cause damage to plants. When large amounts of nutrients are added to the system, pH and electrical conductivity (“EC”) levels destabilize. Damage can occur to plants when the pH and EC levels are significantly above or below their optimal range. Damage caused by incorrect pH or EC levels can impact how much can be harvested and how long it can take to harvest.

Second, conventional hydroponics systems may require growers to monitor the pH and EC levels of the water regularly. Regular monitoring and adjustment is complicated and time-consuming for the average consumer, resulting in neglect, oversights, omissions and errors.

Third, high-levels of nutrients can cause plants to taste bad, so it is often advised that a multi-day flushing period be used before plants are harvested for consumption. This means that there may be a wasteful multi-day period when plants are not growing yet cannot be harvested.

Fourth, metallic sensors in conventional hydroponics systems may degrade. If metallic sensors are used to monitor pH and EC levels, those sensors may quickly degrade and leach dangerous substances into the water and plants.

There is, therefore, a need in the art for a hydroponics system that prevents damaging pH and EC destabilization, avoids the need for growers to engage in complicated and time-consuming monitoring, obviates the need for a flushing period, and avoids the use of metallic sensors.

### SUMMARY OF THE INVENTION

A hydroponics system that uses image processing techniques to automatically manage nutrients is disclosed. The hydroponics system allows small amounts of nutrients to be added to circulated solution on a frequent basis (“micro-dosing”). Micro-dosing allows plants to absorb an appropriate amount of nutrients throughout natural growth cycles.

Images of plants located in a growing area are processed by a computer processor to determine whether the plants are growing. If the plants are growing, a computer processor causes more nutrients to be added to the system than if the plants are not growing. Image processing techniques may include comparing the ratio of plant-related colors to non-plant-related colors in an image or a set of images as well as approaches involving artificial intelligence.

Although specific advantages have been enumerated above, various embodiments may include some, none, or all of the enumerated advantages. Additionally, other technical advantages may become readily apparent to one of ordinary skill in the art after review of the following figures and description.

### BRIEF DESCRIPTION OF DRAWINGS

For a more complete understanding of the present disclosure and its advantages, reference is now made to the following description taken in conjunction with the accompanying drawings, in which like reference numerals represent like parts:

FIG. 1A is a perspective view of a hydroponics system;

FIG. 1B is a perspective view of a hydroponics system;

FIG. 1C is an exploded view of a hydroponics system;

FIG. 2 is a cross-sectional view of a hydroponics system;

FIG. 3 is a cross-sectional view of a hydroponics system;

FIG. 4 is a block diagram illustrating various electronic components in a hydroponics system; and

FIG. 5 is a flow chart illustrating image-based nutrient management in accordance with embodiments of the present disclosure.

### DETAILED DESCRIPTION OF THE INVENTION

It should be understood at the outset that, although exemplary embodiments are illustrated in the figures and described below, the principles of the present disclosure may be implemented using any number of techniques, whether currently known or not. The present disclosure should in no way be limited to the exemplary implementations and techniques illustrated in the drawings and described below. Additionally, unless otherwise specifically noted, articles depicted in the drawings are not necessarily drawn to scale.

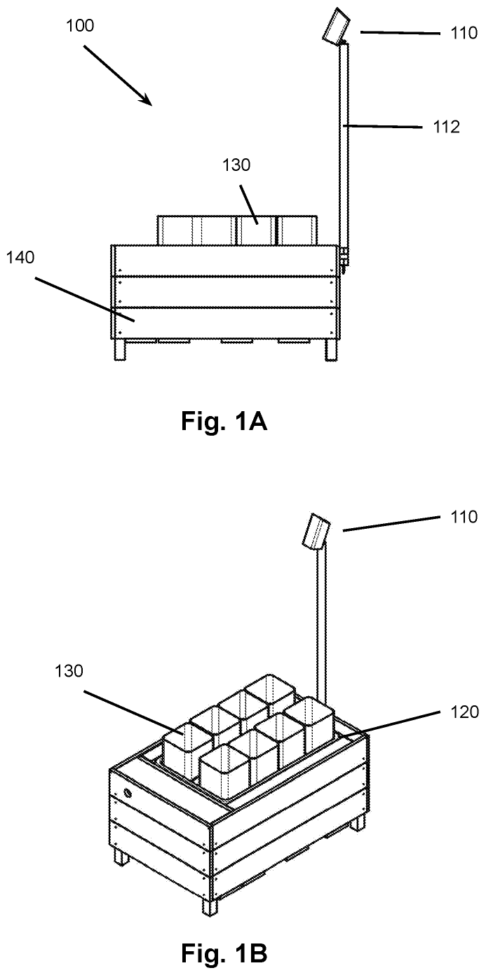

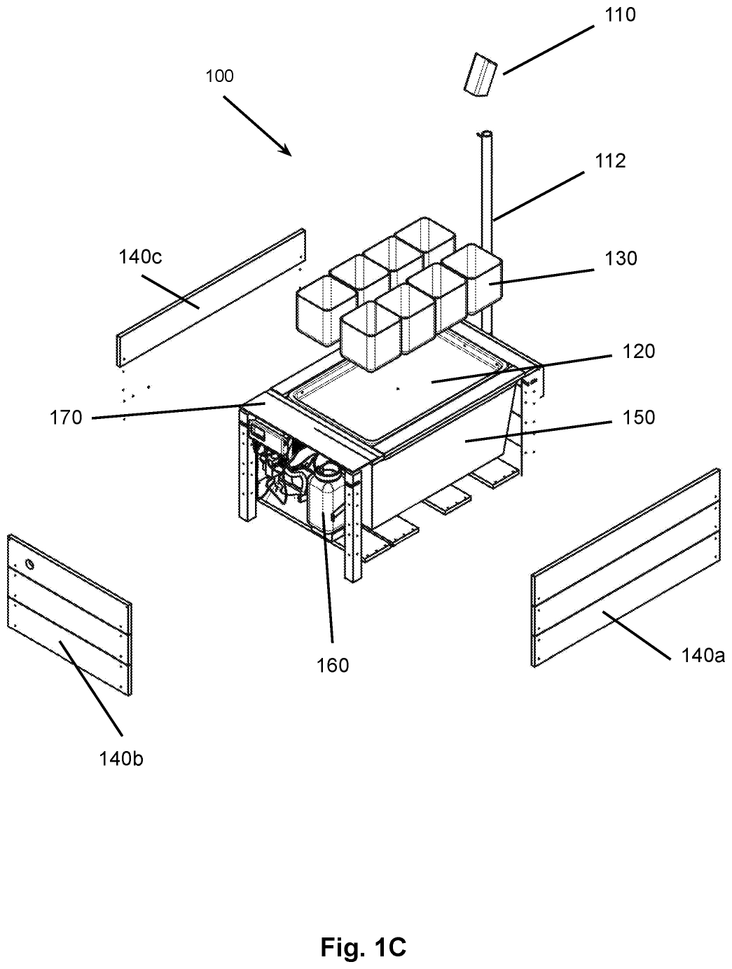

As shown in FIG. 1A, the disclosed hydroponics system 100 may include a camera 110 attached to camera pole 112. As shown in FIG. 1B, the hydroponics system 100 also may also include a growing area 120 in which growing vessels 130 may be placed. The hydroponics system may also include a housing 140 to house electrical components and tanks. In some embodiments, instead of being attached to a camera pole 112, the camera 110 may be attached to a wall or ceiling of a structure or may be attached to a drone hovering above the growing area 120.

As shown in FIG. 1C, the hydroponics system 100 may include a main tank 150 and nutrient reservoir 160. The reservoir may contain a solution of water and plant nutrient. In some embodiments, a solar panel 170 may provide power. Growing vessels 130 may be placed in growing area 120. Growing area 120 may be positioned above the main tank 150.

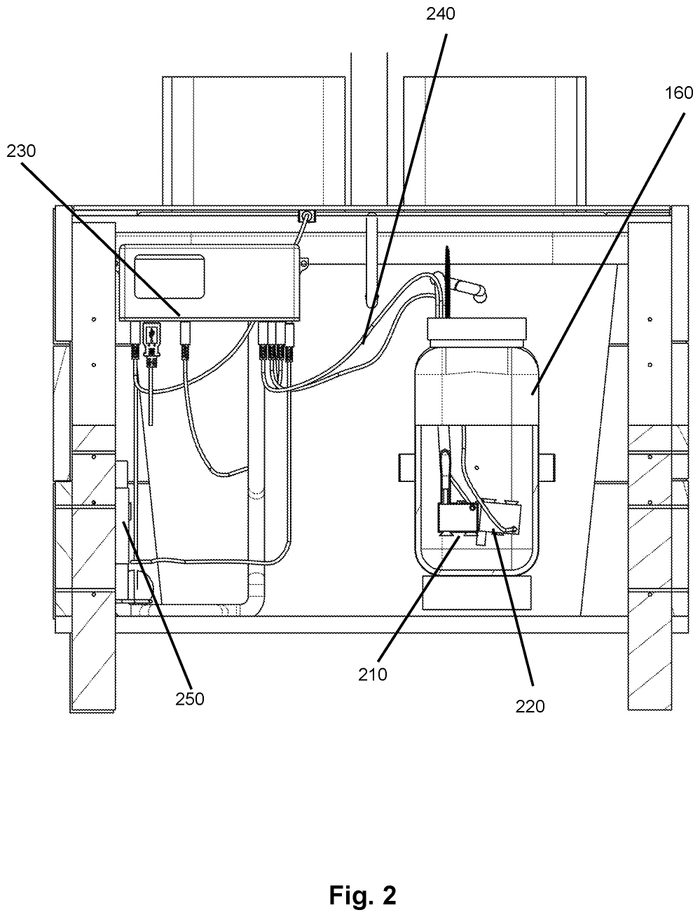

As shown in FIG. 2, a controller 230 may be electrically coupled to a nutrient reservoir pump 210 and nutrient mixing pump 220 with cable 240. The nutrient reservoir pump 210 and nutrient mixing pump 220 may be positioned in the nutrient reservoir 160 along with nutrient solution. A valve 250 may control the flow of water from a water source into main tank 150.

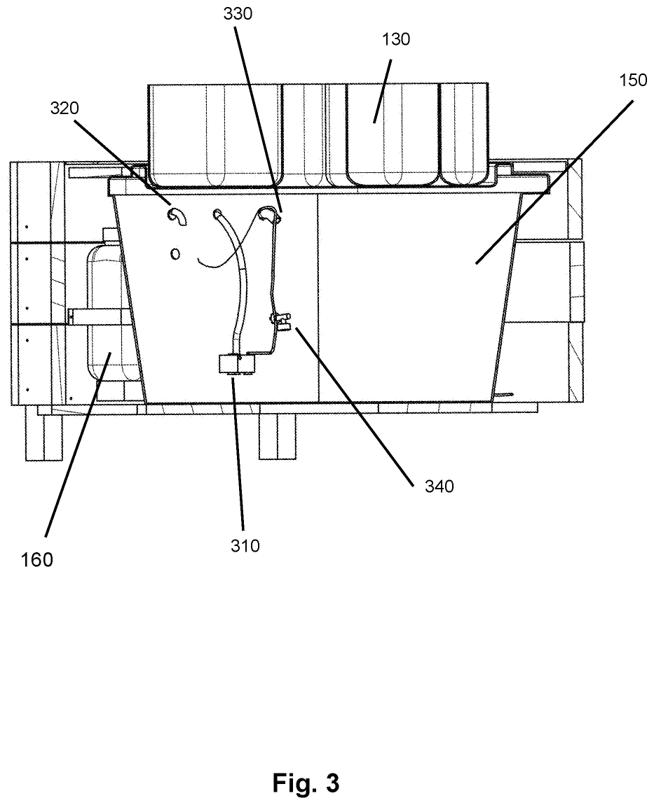

FIG. 3 is a cross-sectional view of a hydroponics system that shows a nutrient supply tube 320, water supply tube 330, water sensor 340, and main tank pump 310 positioned in the main tank 150. Water supply tube 330 may be coupled to valve 250, which may in turn be connected to a water supply. Water sensor 340 may be connected to controller 230 to ensure that the main tank has a sufficient amount of water.

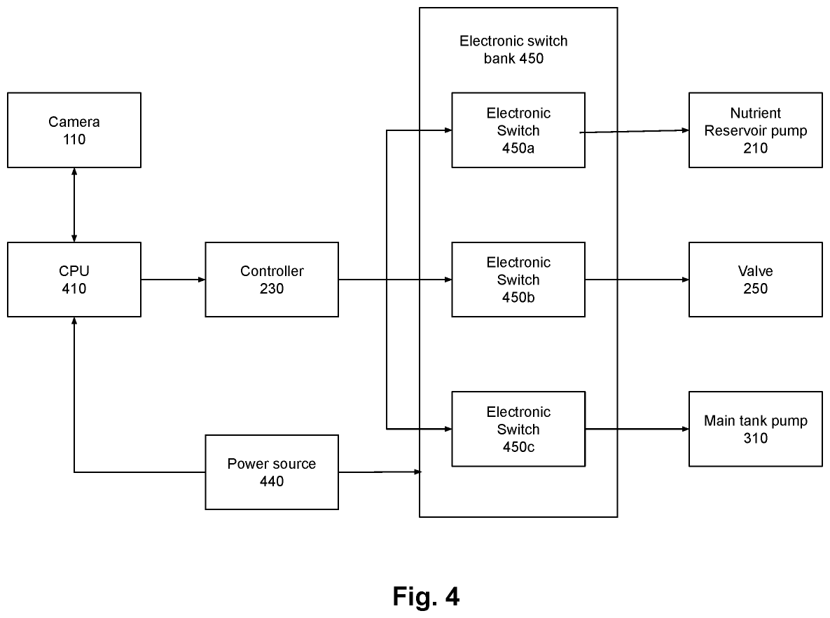

As shown in FIG. 4, the disclosed hydroponics system 100 may comprise various electronic components. A central processing unit (CPU) 410 may be electrically coupled to a camera 110, a controller 230, and a power source 440. The controller 230 may be connected to an electronic switch bank 450, which may contain one or more electronic switches. An electronic switch 450a may be connected to the nutrient reservoir pump 210, an electronic switch 450b may be connected to the valve 250, and an electronic switch 450c may be connected to a main tank pump 310. The controller 230 may activate the electronic switches 450a-450c respectively to turn on and off nutrient reservoir pump 210, valve 250, and main tank pump 310.

In an exemplary embodiment, CPU 410 is a Raspberry Pi, nutrient reservoir 160 is a glass container, nutrient reservoir pump 210 is a DC 12V pump, controller 230 is an Arduino, main tank 150 is a food-grade, 27-gallon polypropylene container, main tank pump 310 is a DC 12V pump, camera 110 is a Raspberry Pi-compatible, 5-megapixel camera, growing area 120 comprises a plastic tray with drainage and overflow holes, power source 440 is a 12V DC power supply, and nutrients are MaxiGro from General Hydroponics. The CPU 410 may be connected to the camera 110 with a 6-inch ribbon cable. The camera 110 may be housed in a weatherproof container and suspended approximately 36 inches above the growing area by camera pole 112 so the camera can clearly see the growing area 120.

In some embodiments, the CPU 410 and controller 230 are on a single circuit board. In another embodiment, the nutrient reservoir and nutrient reservoir pump may be replaced by dry nutrient, such as a powder or pellets. In some embodiments, the growing vessels 130 may be felt or woven bags that hold perlite or other inert media for root growth.

In one embodiment, growing vessels 130 may be positioned on a growing area 120 above the main water tank. In one embodiment, the water tank pump 310 may be positioned inside the main water tank 150 and may be connected to a water supply tube 330 that adds water to the bottom of growing area 120 when the main tank pump is activated. The growing area 120 may also have drain holes and overflow holes that allow water to drain back into the main tank 150.

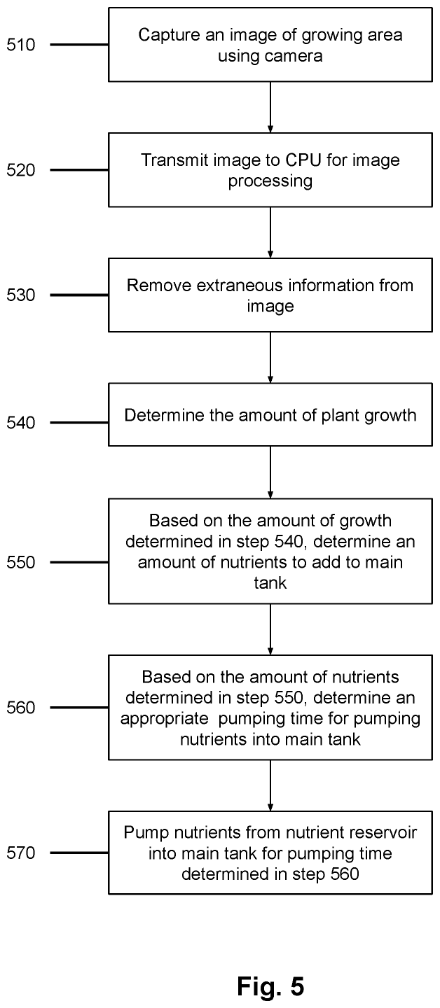

FIG. 5 illustrates an exemplary method for managing nutrients in a hydroponics system using image processing. At step 510, the CPU 410 may direct the camera 110 to capture an image of growing area 120. At step 520, camera 110 may transmit the captured image to the CPU 410 either through a wired connection or wirelessly. After receiving the image of the growing area 120, the CPU 410 may process the image. At step 530, image processing may include removing extraneous information (e.g., masking out parts of the image not relevant to the plants being analyzed).

At step 540, the image is processed to determine the amount or rate of plant growth. Image processing may include determining the ratio of colors that show plant growth (e.g. greens to purples) to colors not associated with plant growth (e.g. brown). In some embodiments, histogram software may sort image pixels into tonal categories that are then used to isolate colors relevant to the amount of foliage in the picture.

Python modules such as CV2 and Numpi may be used to calculate ratios. In some embodiments, a set of daily images may be used with object recognition software to determine whether individual plants have experienced leaf growth. In some embodiments, periodic histograms may be used to analyze an increase in plant-related colors over time rather than a static ratio.

At step 550, based on the amount of plant growth determined through image processing, the CPU 410 may determine an amount of nutrients to add to main tank 150. If a liquid nutrient is used, determining the amount of nutrients to add may involve determining a pumping time appropriate for the amount of nutrients to be added. If a dry nutrient is used, determining the amount of nutrients to be added may involve calculating the number of units (e.g. pellets or spoons) of dry nutrients that should be added.

At step 560, based on the amount of nutrients determined in step 550, the CPU may determine an appropriate pumping time for pumping nutrients into the main tank. The controller 230 may receive instructions from the CPU 410. The transmitted instructions may specify how much nutrient to add using the nutrient reservoir pump 210 (e.g. by specifying a pumping time).

At step 570, nutrients are pumped from the nutrient reservoir into the main tank for the pumping time determined in step 560. The controller 230 may activate switch 450a connected to the nutrient reservoir pump 210 to pump nutrients from the nutrient reservoir 160 to the main tank 150. The CPU 410 ensures an appropriate pumping time. The controller 230 may turn off the electronic switch 450a to stop pumping nutrients. The controller 230 may cause solution from the main tank 150 to be added to the growing area 120 and circulate among the plant roots in growing vessels 130.

In an exemplary embodiment, liquid nutrients (e.g. a solution of one-fourth cup MaxiGro to one half gallon of water) are added to the hydroponics systems based on the ratio of plant colors to non-plant colors. No nutrients are added to the water in the main tank when seeds are initially planted. The camera 110 captures images of the growing area 120 on a daily basis while the seeds are germinating. Pumping occurs once a day after the image has been analyzed by the CPU 410. If the ratio of plant colors (e.g. green) to non-plant colors (e.g. brown) is greater than 0.5, nutrients are pumped for 5 seconds. If the ratio of plant colors to non-plant colors is less than or equal to 0.5 but greater than 0, nutrients are pumped for 2 seconds. If the ratio of plant colors to non-plant colors equals 0, nutrients are not pumped. The described rate of image capture, rate of pumping, pumping times, and color ratios are for exemplary purposes only; other rates, times, and ratios may be used. Pumping time periods may vary by type of nutrients, size of reservoir, concentration of nutrients, etc.

Image processing to determine the amount or rate of plant growth may include techniques involving artificial intelligence. Software approaches for recognizing plant growth or present state may include convolutional neural networks, recurrent neural networks, k-means neural networks, and histograms. These approaches may be implemented with software such as TensorFlow and or Open Computer Vision. These software tools may be employed to learn what successful horticulture looks like or used to match the present state of plants to existing known parameters of plant mass, structure, and color in a defined growing area. Training of neural networks may be accomplished by first labeling images or videos as either successful or unsuccessful and then processing the images and videos to create a model that can be used with real world data.

The disclosed hydroponics systems may be used to grow various plants, including lettuce, kale, chard, beets, tomatoes, cucumbers, squash, radishes, turnips, bok choy, mizuna, cabbage, collards, papayas, potatoes, sweet potatoes, turmeric, ginger, chives, garlic, beans, strawberries, watermelon, bitter melon, winter melon, rosemary, basil, oregano, marjoram, thyme, celery, broccoli, cauliflower, Hawaiian chili pepper, sweet peppers, habaneros, and most other produce.

Modifications, additions, or omissions may be made to the systems, apparatuses, and methods described herein without departing from the scope of the disclosure. For example, the components of the systems and apparatuses may be integrated or separated. Moreover, the operations of the systems and apparatuses disclosed herein may be performed by more, fewer, or other components and the methods described may include more, fewer, or other steps. Additionally, steps may be performed in any suitable order. As used in this document, “each” refers to each member of a set or each member of a subset of a set.

What is claimed is:

1. A hydroponics system comprising:
a camera;
a controller;
a main tank;
a main tank pump disposed in the main tank and electrically coupled to the controller;
a nutrient reservoir;
a nutrient reservoir pump disposed in the nutrient reservoir and electrically coupled to the controller;
a nutrient supply tube in communication with the main tank and nutrient reservoir pump; and
a CPU electrically coupled to the camera and controller and configured to execute a plurality of computer-readable instructions to perform operations comprising:
receiving an image of a growing area from the camera;
processing the image to calculate an amount of plant growth;
based on the calculated amount of plant growth, calculating an amount of nutrients to add to the main tank;
based on the calculated amount of nutrients to be added to the main tank, calculating an appropriate pumping time for pumping nutrients into the main tank;
and sending instructions to the controller to cause the nutrient reservoir pump to pump nutrients from the nutrient reservoir into the main tank for the calculated pumping time.

2. The hydroponics system of claim 1, wherein processing the image to calculate an amount of plant growth comprises determining a ratio of colors associated with plant growth to colors not associated with plant growth.

3. The hydroponics system of claim 2, wherein determining a ratio of colors comprises using histogram software to sort image pixels into tonal categories that isolate colors relevant to foliage depicted in the image of the growing area received from the camera.

4. A method for managing nutrients in a hydroponics system, comprising:
providing a hydroponics system comprising:
a CPU;
a camera electrically coupled to the CPU;
a controller electrically coupled to the CPU;
a main tank;
a main tank pump disposed in the main tank and electrically coupled to the controller;
a nutrient reservoir;
a nutrient reservoir pump disposed in the nutrient reservoir and electrically coupled to the controller;
a nutrient supply tube in communication with the main tank and nutrient reservoir pump;
one or more processors;
capturing an image of a growing area using a camera;
transmitting the image to a CPU;
processing the image to determining an amount of plant growth;
based on the amount of plant growth, determining an amount of nutrients to add to a main tank;
based on the amount of nutrients to be added to the main tank, calculating a pumping time for pumping nutrients into the main tank;
pumping nutrients from a nutrient reservoir into the main tank for the calculated pumping time.

5. The method of claim 4, wherein processing the image to determining an amount of plant growth comprises determining a ratio of colors associated with plant growth to colors not associated with plant growth.

6. The method of claim 5, wherein determining a ratio of colors comprises using histogram software to sort image pixels into tonal categories that isolate colors relevant to foliage depicted in the image of the growing area received from the camera.
